(19) United States
(12) Patent Application Publication
(10) Pub. No.: US 2020/0050996 A1
(43) Pub. Date: Feb. 13, 2020

(54) HIGH LEVEL WORKFORCE AS A SERVICE DELIVERY USING A CLOUD-BASED PLATFORM

(71) Applicant: ServiceNow, Inc., Santa Clara, CA (US)

(72) Inventors: Tasker O. Generes, JR., Northfield, IL (US); Robert Joseph Osborn, II, Bangs, TX (US); Brian M. Crosby, Fairfax, VA (US)

(21) Appl. No.: 16/059,667

(22) Filed: Aug. 9, 2018

(51) Int. Cl. G06Q 10/06; G06Q 10/10

(52) U.S. Cl. CPC G06Q 10/063112; H04L 67/10; G06Q 10/105; G06Q 10/1097

(57) ABSTRACT

A network-based system to properly assign work items to be performed by workers across a network architecture. Candidate workers may be provided by receiving, from a task requestor instance on an enterprise management platform, a request for candidate users for a first task, wherein the request comprises one or more request parameters, identifying, from a user directory, a first plurality of users based on the first task, refining the first plurality of users to obtain the candidate users based on user metrics for each user provided by one or more community users, wherein the community users are different than the task requestor and the respective plurality of users, wherein the one or more request parameters indicates a perceived skill level of the respective user for the task by the one or more community users, and transmitting, to the task requestor instance, a message comprising the candidate users.

### TECHNICAL FIELD

Embodiments described herein generally relate to cloud computing and, in particular, to executing, managing, tracking and assigning work items to individuals and automated systems using a cloud-based platform. In particular, but not by way of limitation, embodiments describe a method and system to manage task requests, identify candidates for the task based on candidate assets and community-provided metrics, and assign the task to a selected candidate.

### BACKGROUND

Cloud computing involves sharing of computing resources that are generally accessed via the Internet. In particular, the cloud computing infrastructure allows users, such as individuals and/or enterprises (the terms enterprise(s) and organization(s) are used interchangeably in the context of this disclosure), to access a shared pool of computing resources, such as servers, storage devices, networks, applications, and/or other computing-based services. By doing so, users are able to access computing resources located at remote locations in an “on demand” fashion in order to perform a variety of computing functions that include storing and/or processing computing data. For enterprises, cloud computing provides flexibility in accessing cloud computing resources without accruing excessive up-front costs, such as purchasing network equipment and/or investing time in establishing a private network infrastructure. Instead, by utilizing cloud computing resources, users are able to redirect their resources to focus on core enterprise functions.

In today's communication networks, examples of cloud computing services that a user may utilize include software as a service (SaaS) and platform as a service (PaaS) technologies. SaaS is a delivery model that provides software as a service, rather than as an end product. Instead of utilizing a local network or individual software installations, software is typically licensed on a subscription basis, hosted on a remote machine, and accessed as needed. For example, users are generally able to access a variety of enterprise and/or information technology (IT) related software via a web browser. PaaS acts an extension of SaaS that goes beyond providing software services by offering customizability and expandability features to meet a user's needs. For example, PaaS can provide a cloud-based developmental platform for users to develop, modify, manage, and/or customize applications and/or automate enterprise operations without maintaining network infrastructure and/or allocating computing resources normally associated with these functions.

### BRIEF DESCRIPTION OF DRAWINGS

For a more complete understanding of this disclosure, reference is now made to the following brief description, taken in connection with the accompanying drawings and detailed description, wherein like reference numerals represent like parts.

FIG. 1 illustrates a block diagram of an embodiment of a network infrastructure 100 that includes a cloud computing system and customer network (e.g., private network) where embodiments of the present disclosure may operate.

FIG. 2 illustrates a block diagram of a network infrastructure over which candidate users may be requested and identified, according to one or more embodiments.

FIG. 3 illustrates a block diagram of different entities and how their interactions may be coordinated in an automated task-scheduling system, according to one or more disclosed embodiments.

FIG. 4 illustrates a block diagram of a second example of different entities and associated metrics with respect to how their interactions may be coordinated in an automated task-scheduling system, according to one or more disclosed embodiments.

FIG. 5 illustrates a flow chart 500 of one possible flow from the perspective of a company, according to one or more disclosed embodiments.

FIG. 6A illustrates a flow chart 600 of one possible feedback loop for use in maintaining subjective measurements, according to one or more disclosed embodiments.

FIG. 6B illustrates three flow charts 625, 650, and 680 from a perspective of an individual resource, community of individuals, and company, respectively, according to one or more disclosed embodiments.

FIG. 7 illustrates possible attributes of items that may be tracked in accordance with one or more disclosed embodiments.

FIG. 8 illustrates one possible process for managing human work, according to one or more disclosed embodiments.

FIG. 9 illustrates one possible process for managing machine (i.e., automated) work, according to one or more disclosed embodiments.

FIG. 10 illustrates an overview of a possible Service Management Platform, according to one or more disclosed embodiments.

FIG. 11 illustrates an example flow diagram of a task request among various instances on an enterprise management platform, according to one or more embodiments.

FIG. 12 illustrates a block diagram of a computing device 200 that may be used to implement processes described as being performed, for example, by a computer system or processing device, according to one or more disclosed embodiments.

### DESCRIPTION OF EMBODIMENTS

In the following description, for purposes of explanation, numerous specific details are set forth in order to provide a thorough understanding of the embodiments disclosed herein. It will be apparent, however, to one skilled in the art that the disclosed embodiments may be practiced without these specific details. In other instances, structure and devices are shown in block diagram form in order to avoid obscuring the disclosed embodiments. References to numbers without subscripts or suffixes are understood to reference all instance of subscripts and suffixes corresponding to the referenced number. Moreover, the language used in this disclosure has been principally selected for readability and instructional purposes and may not have been selected to delineate or circumscribe the inventive subject matter, resort to the claims being necessary to determine such inventive subject matter. Reference in the specification to “one embodiment” or to “an embodiment” means that a particular feature, structure, or characteristic described in connection with the embodiments is included in at least one embodiment.

The terms “a,” “an,” and “the” are not intended to refer to a singular entity unless explicitly so defined, but include the general class of which a specific example may be used for illustration. The use of the terms “a” or “an” may therefore mean any number that is at least one, including “one,” “one or more,” “at least one,” and “one or more than one.” The term “or” means any of the alternatives and any combination of the alternatives, including all of the alternatives, unless the alternatives are explicitly indicated as mutually exclusive. The phrase “at least one of” when combined with a list of items, means a single item from the list or any combination of items in the list. The phrase does not require all of the listed items unless explicitly so defined.

As used herein, the terms “computing system” or “computer system” refer to a single electronic computing device that includes, but is not limited to a single computer, virtual machine, virtual container, host, server, laptop, and/or mobile device or to a plurality of electronic computing devices working together to perform the function described as being performed on or by the computing system or computer system.

As used herein, the term “medium” refers to one or more non-transitory physical media that together store the contents described as being stored thereon. Embodiments may include non-volatile secondary storage, read-only memory (ROM), and/or random-access memory (RAM).

As used herein, the term “application” refers to one or more computing modules, programs, processes, workloads, threads, and/or a set of computing instructions executed by a computing system. Example embodiments of an application include software modules, software objects, software instances, and/or other types of executable code.

As used herein, the terms “task” or “work item” refer to a predefined unit of work that may be satisfied with a “work product” conforming to the requirements of that task as reflected in a “task definition.” A “work product” may represent a draft document, source code application, project plan, completed document (e.g., edited by professional editor), computational result, or the like. In general, the work product represents a completed task (or job) that may represent a portion of an overall work project. As an example, a draft document may need to be reviewed by a professional editor. A “task” may be defined to identify the need for a professional editor to update the draft document. The professional editor may obtain a copy of the draft document, perform the editing as requested in the task requirements, and return the resulting “edited document” as the work product. A set of related tasks may be grouped to represent a “job” with an overall set of requirements instead of, or in addition to, individual requirements for each task. The result of a job may include one or more work product artifacts.

Using the disclosed techniques for dynamic assignments of operations within a task flow represents an improvement to the technology area of dispatching, load balancing, and flexibility of job scheduling techniques as used within multi-device computer networks. Disclosed techniques address a need to balance between private network infrastructure and cloud-based infrastructure to properly address distributed computing needs in the growing environment of SaaS and PaaS systems. Disclosed techniques also introduce the concept of performing WaaS on a system that may be designed to integrate with a traditional SaaS, and/or PaaS scheduling system (as well as a traditional human resource scheduling system (e.g., project planning software)).

Within the context of automating enterprise, IT, and/or other organization-related functions (e.g., human resources (HR)), PaaS often provides users an array of tools to implement complex behaviors, such as enterprise rules, scheduled jobs, events, and scripts, to build automated processes and to integrate with third party systems. Although the tools for PaaS generally offer automated load balancing of tasks and task assignments, the criteria used to assign work items for execution is generally directed to compute resource capability. In general, previous implementations of load balancing of tasks and task assignments completely ignore subjective factors. That is, tasks are generally assigned based on memory availability, processor availability, and other directly measured metrics with respect to available capacity of compute resources across a computer infrastructure.

In a first example implementation according to embodiments of this disclosure, a cloud-based computer system for identifying, categorizing, and managing differing views of WaaS exists. This enables enterprise customers to manage their workforce by quickly identifying candidates based on requested criteria, such as technological assets. Candidates may be presented along with an indication of a skill level based on community feedback.

The first example may be extended such that various parties may control access to various data. For a client organization, this control may include access to information with different degrees of input or filtering from both internal and external entities with respect to the organization. For example different actors involved in an overall work project may have different access levels to the source of the work description and control functions. In general, an implementation representing humans as an extension of IOT devices (e.g., IOT Human) may lend itself to a categorization of humans as assets or resources that may be applied to work or multiple applications of work simultaneously and for different organizations. Similarly, users, such as the human or IOT Human, may also control access to various aspects of their data. That is, the user may be part of two or more communities (i.e., the user may be a candidate for two or more types of tasks), but the user may restrict which data organizations or communities may access of their profile.

In the above example, work may be defined by a party within the community of interest. Work items (e.g., tasks) may be requested by a customer company, work items may be completed (e.g., after dispatch or negotiation and dispatch) by a human user or machine, completed work items may be “graded” (e.g., adding a performance assessment) by some or all actors involved in the completion of the work item(s) (based on subjective perspectives). For example, work items may be evaluated by community members that may have some knowledge or interest in the user's work, and may be different than the customer company. Work items may be further valued, and through the utilization of the “work as a service” infrastructure as supported by SaaS capability, valued at a known (and agreed upon) value (e.g., compensation value). There may also be crowd-sourcing elements that may be used to extend this example as well as gamification elements that may assist in refining each view and outcome.

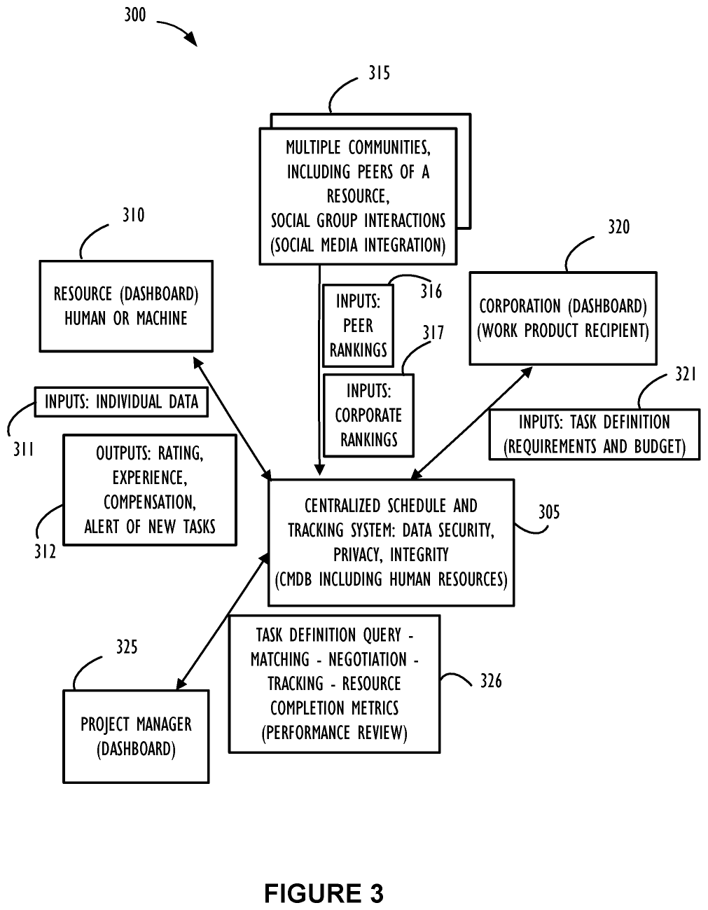

In general, by connecting work items and resources, for example using WaaS data, people (e.g., as represented in different contexts the three views (310, 315, 320) of FIG. 3), and interaction among elements may allow a system to gain insight and control of the information from different user perspectives. Each user may be presented a view (e.g., dashboard) created by the disclosed system to interact with others from each of their perspective roles. Thus, they may be able to appropriately influence the outcome of a WaaS project implementation.

The disclosed scheduling, tracking, and dispatching system may be conceptualized as a WaaS system and may include many different capabilities to utilize and coordinate across a dispersed work force that augments (or replaces) a traditional work force. For example, a user, or worker, may be empowered to work for multiple customer companies, while the companies may more readily identify candidate job seekers for a particular task. The disclosed system may “dispatch” tasks or jobs (e.g., groups of tasks) for execution. The disclosed system may then monitor and collect work product reflecting completion of these tasks/jobs. This work product may be combined with traditional work product to produce a desired result. Additionally, the scheduling of these WaaS task items may be integrated into a traditional enterprise scheduling system where assignments may be made using criteria about employee availability and indications about where WaaS efforts may be of most benefit.

In particular, the disclosed system may create, track, and maintain both objective and subjective measurements to outsource tasks and integrate their results with traditional in-house, employee-based, work products. In addition, the various metrics may be utilized by user job seekers in a user directory to indicate particular skills and reports. Introducing subjective measurements, and in particular, introducing subjective measurements that have been processed to reflect a very high degree of accuracy represents an improvement to the technology area of load balancing, task assignment, and overall completion of work items for an enterprise. Subjective measurements include, but are not limited to, opinion-type responses related to historical work efforts. For example, likes to a post in social media, work performance reviews, customer satisfaction polls, peer-review ratings, and the like.

Subjective measurements of this type are not exact and may sometimes reflect an artificially imposed positive or negative bias on the metric. In one example, a server that performed a function may have received a low customer-satisfaction rating because a network switch (generally not directly related to the server) had a malfunction while performing a work item for a customer. That customer was unsatisfied and gave the server a bad rating. If, on the other hand, the network switch had not failed at that time, the customer likely would have given the server a good rating (as reflected by other customer subjective ratings over time). By understanding the correlation between the network switch, the server, and this customer's biased review, the subjective measurements may be utilized in a more effective and predictively accurate (do not expect same problem in future) manner.

Achieving the correct balance between cloud-based automated resources and human activities remains a dynamic problem for some of today's enterprises. Some work items may be automated while other work items may only be performed by a human being (or may require oversight of a human being). As Artificial Intelligence (AI) and machine learning capabilities increase, it may be expected that the percentage of oversight (when required) will decrease. Accordingly, a system designed to balance the proper assignment of tasks (work items) to individuals should provide benefit to an enterprise and allow for utilization of a more virtual work force. The virtual work force may be reflected by employees that are neither full-time nor dedicated to any given employer, but that work on (and are compensated for) individual work items. In theory, human beings may be considered assets of an enterprise infrastructure that may be assigned work items in a manner similar to historical load balancing and distribution techniques of a computer infrastructure. Of course, criteria different than that used for traditional computer load balancing, such as the subjective ratings criteria mentioned above, may assist in proper assignment of tasks in a hybrid human/machine infrastructure. Each work or task request may include a work type designator to identify: if a human being is required to perform the work of the task, if a machine is required to perform the work of the task, or if any available resource may perform the work of the task. In particular, some task requests may be completed with units of work related to the task being accomplished by a combination of computer resources and non-machine resources (i.e., human resources).

In traditional task scheduling systems for computer-automated work, an overall definition of a configured, automated process for addressing one or more work functions may be broken down into one or more discrete “operations.” Each operation may include a logical unit of work that may be completed individually with the sum of all logical units of work (i.e., operations) representing the work of the “flow plan.” As used herein, a “task flow” represents an individual instance of a flow plan, which may be thought of as a run-time copy of a corresponding flow plan. In one or more embodiments, the work functions for the flow plan may correspond to a variety of enterprise-related functions. Categories of tasks that relate to enterprise—related functions include, but are not limited to, HR operations, customer service, security protection, enterprise applications, IT management, and/or IT operation. Although, some task flows will remain within a single organizational domain, such as HR operations (e.g., salary adjustment); other task flows may include operations that affect several organizational domains, (e.g., employee termination may affect HR operations to perform the termination action, but may also invoke IT management and/or operations to disable user access accounts). In the disclosed WaaS system, task flows may be expanded to extend beyond any traditional organizational boundaries. As a result, task flows may include operations (e.g., tasks or jobs) that are performed by external cloud-based, or cloud-connected, resources.

Compute and Human resources to produce work product may reside in many different locations throughout the customer's total infrastructure (e.g., including externally available resources from a cloud). Multiple flow engines may be used to coordinate processing of each active task flow definition and provide alerts to Human resources or schedule automated tasks on compute resources. Coordinating processing may include the following operations: determining proper execution environments (e.g., particular human resources or compute resources); facilitating transfer of operations and their execution requirements between different execution environments as the “proper” execution environment dynamically changes; and maintaining status of in-progress and completed task flows. While a task flow is active, different operations within the task flow definition may require different execution environments to function properly—or more optimally. In some cases, a subset of operations of a task flow definition may be agnostic to their execution environment and may function equally well in all possible execution environments. In still another case, some operations may have attributes of their definition that favor one environment over another even though both environments may be able to properly execute the operation.

Many combinations and permutations of operations and execution environments are possible, so long as compliance with the respective requirements of each operation is maintained. Thus, it would be desirable to optimize the overall task flow execution by selecting the proper execution environment dynamically, e.g., while the task flow is being processed, because operational attributes regarding load, capacity, and/or availability of execution environments may change after the initiation of the task flow. This may be especially true for any long-running task flow definitions. For example, if a human resource becomes sick, it may be desirable to transfer any tasks assigned to that human resource for a period of time while the human resource recovers from the illness. However, if the system discovers that an overall schedule may not be affected by expected delay caused by the sickness, then the task may simply be left with the current resource for completion. Historical information about this resource and its “wellness” history may be tracked by the system as part of this determination.

Having an understanding of the above brief overview of task flows, operations, execution environments, and WaaS, which may be implemented using a portion of network infrastructure 100, more detailed examples and embodiments are explained with reference to the drawings as necessary.

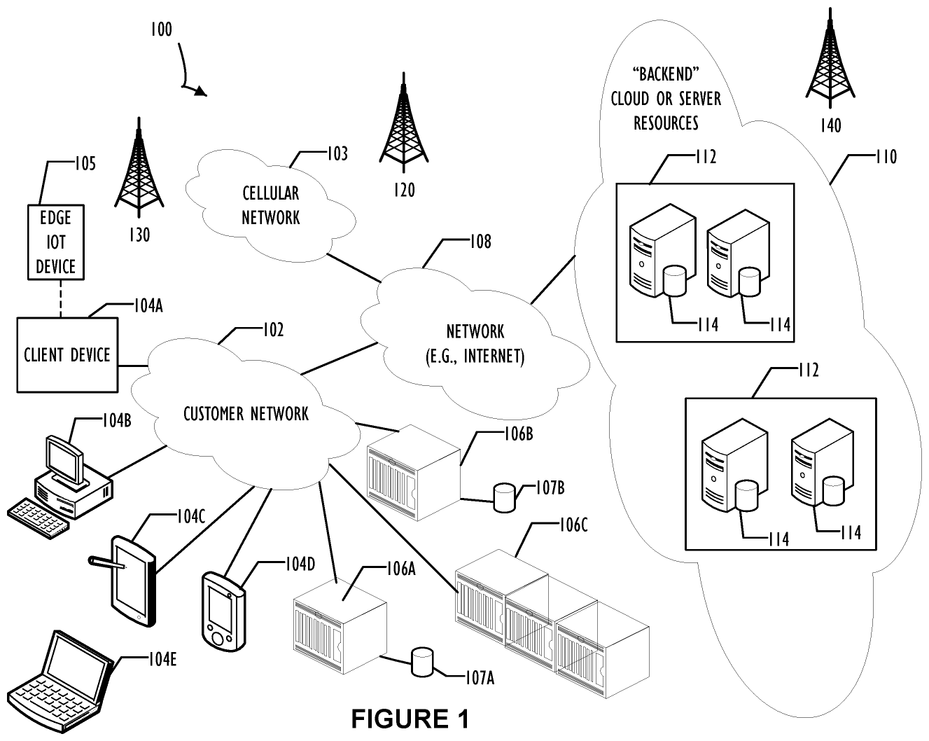

FIG. 1 illustrates a block diagram of an embodiment of network infrastructure 100 that includes a set of networks where embodiments of the present disclosure may operate. Network infrastructure 100 comprises a customer network 102, network 108, and a cloud service provider network 110. In one embodiment, the customer network 102 may be a local private network, such as local area network (LAN) that includes a variety of network devices that include, but are not limited to switches, servers, and routers. Each of these networks can contain wired or wireless programmable devices and may operate using any number of network protocols (e.g., TCP/IP) and connection technologies (e.g., WiFi® networks (WI-FI is a registered trademark of the Wi-Fi Alliance), Bluetooth® (BLUETOOTH is a registered trademark of Bluetooth Special Interest Group)). In another embodiment, customer network 102 represents an enterprise network that could include or be communicatively coupled to one or more LANs, virtual networks, data centers and/or other remote networks (e.g., 108, 110).

As shown in FIG. 1, customer network 102 may be connected to one or more client devices 104A-104E and allow the client devices 104A-104E, and human resources (not shown) that interact with client devices 104A-104E, to communicate with each other and/or with cloud service provider network 110, via network 108 (e.g., Internet). Client devices 104A-104E may be computing systems such as desktop computer 104B, tablet computer 104C, mobile phone 104D, laptop computer (shown as wireless) 104E, and/or other types of computing systems generically shown as client device 104A. Network infrastructure 100 may also include other types of devices generally referred to as Internet of Things (IOT) (e.g., edge IOT device 105) that may be configured to send and receive information via a network to access cloud computing services or to interact with a remote web browser application (e.g., to receive configuration information). In some implementations of this disclosure, human resources are treated and processed as if they were represented as edge IOT device 105. That is, the requests and responses to a human resource may be configured to be processed with respect to scheduling of work as if the human resource was an IOT device. Further, in one or more embodiments, human resources may include technological assets such that the user with the assets may be treated, for example, as an IOT device. As an example, a user may have assets that are IOT or other network devices. As another example, a user may be an enhanced human and may have assets that are technological enhancements, such as enhanced strength, enhanced sight, technological implants, and the like.

FIG. 1 also illustrates that customer network 102 includes local compute resources 106A-106C that may include a server, access point, router, or other device configured to provide for local computational resources and/or to facilitate communication amongst networks and devices. For example, local compute resources 106A-106C may be one or more physical local hardware devices, such as a management instrumentation and discovery (MID) server, that facilitate communication of data between customer network 102 and other networks, such as network 108 and cloud service provider network 110. Local compute resources 106A-106C may also facilitate communication between other external applications, data sources (e.g., 107A and 107B), and services and customer network 102. In network infrastructure 100, local compute resource 106A represents a MID server with singular access to data source 107A. That is, 107A is private data to MID server 106A in this example. Accordingly, any operation that requires access to data source 107A must execute on MID server 106A. Similarly, in this example, data source 106B is dedicated to MID server 106B. Local compute resource 106C illustrates a MID server cluster with three nodes. Of course, any number of nodes is possible, but three are shown in this example for illustrative purposes. In the context of the current disclosure, this example illustrates that those three nodes may be considered equivalent to each other as far as capabilities to perform operations designated for MID server 106C. It is noted that internal load balancing mechanisms (e.g., cluster load balancing) may further assist the overall operation assignment techniques used for optimal task flow execution according to disclosed embodiments.

Network infrastructure 100 may also include cellular network 103 for use with mobile communication devices. Mobile cellular networks support mobile phones and many other types of mobile devices, such as laptops, etc. Mobile devices in network infrastructure 100 are illustrated as mobile phone 104D, laptop computer 104E, and tablet computer 104C. A mobile device may interact with one or more mobile provider networks as the mobile device moves, typically interacting with a plurality of mobile network towers 120, 130, and 140 for connecting to the cellular network 103. Although referred to as a cellular network in FIG. 1, a mobile device may interact with towers of more than one provider network, as well as with multiple non-cellular devices, such as wireless access points and routers (e.g., local compute resources 106A-106C). In addition, the mobile devices may interact other mobile devices or with non-mobile devices, such as desktop computer 104B and various types of client device 104A, for desired services. Although not specifically illustrated in FIG. 1, customer network 102 may also include a dedicated network device (e.g., gateway or router) or a combination of network devices that implement a customer firewall or intrusion protection system.

FIG. 1 illustrates that customer network 102 is coupled to a network 108. Network 108 may include one or more computing networks available today, such as other LANs, wide area networks (WANs), the Internet, and/or other remote networks, in order to transfer data between client devices 104A-104E and cloud service provider network 110. Each of the computing networks within network 108 may contain wired and/or wireless programmable devices that operate in the electrical and/or optical domain. For example, network 108 may include wireless networks, such as cellular networks in addition to cellular network 103. Wireless networks may utilize a variety of protocols and communication techniques (e.g., Global System for Mobile Communications (GSM) based cellular network) wireless fidelity Wi-Fi networks, Bluetooth, Near Field Communication (NFC), and/or other suitable radio based network as would be appreciated by one of ordinary skill in the art upon viewing this disclosure. Network 108 may also employ any number of network communication protocols, such as Transmission Control Protocol (TCP) and Internet Protocol (IP). Although not explicitly shown in FIG. 1, network 108 may include a variety of network devices, such as servers, routers, network switches, and/or other network hardware devices configured to transport data over networks.

In FIG. 1, cloud service provider network 110 is illustrated as a remote network (e.g., a cloud network) that is able to communicate with client devices 104A-104E via for example, customer network 102 and network 108, or any other available network communication paths. The cloud service provider network 110 acts as a platform that provides additional computing resources to the client devices 104A-104E and/or customer network 102. For example, by utilizing the cloud service provider network 110, users of client devices 104A-104E may be able to build and execute applications, such as automated processes for various enterprise- and/or IT-related functions. In one embodiment, cloud service provider network 110 includes one or more data centers 112, where each data center 112 could correspond to a different geographic location. Within a particular data center 112, a cloud service provider may include a plurality of server instances 114. Each server instance 114 may be implemented on a physical computing system, such as a single electronic computing device (e.g., a single physical hardware server) or could be in the form a multi-computing device (e.g., multiple physical hardware servers). Examples of server instances 114 include, but are not limited to, a web server instance (e.g., a unitary Apache® installation (APACHE is a registered trademark owned by The Apache Software Foundation), a WaaS server, an application server instance (e.g., unitary Java® Virtual Machine (JAVA is a registered trademark owned by Sun Microsystems)), and/or a database server instance (e.g., a unitary MySQL® catalog (MYSQL is a registered trademark owned by MySQL AB A COMPANY)).

To utilize computing resources within cloud service provider network 110, network operators may choose to configure data centers 112 using a variety of computing infrastructures. In one embodiment, one or more of data centers 112 are configured using a multi-tenant cloud architecture such that a single server instance 114, which can also be referred to as an application instance, handles requests and serves more than one customer. In some cases, data centers with multi-tenant cloud architecture commingle and store data from multiple customers, where multiple customer instances (not shown in FIG. 1) are assigned to a single server instance 114. In a multi-tenant cloud architecture, the single server instance 114 distinguishes between and segregates data and other information of the various customers. For example, a multi-tenant cloud architecture could assign a particular identifier for each customer in order to identify and segregate the data from each customer into a customer instance executing on that single server instance. In a multi-tenant environment, multiple customers share the same application, running on the same operating system, on the same hardware, with the same data-storage mechanism. The distinction between the customers is achieved during application design, thus customers do not share or see each other's data. This is different than virtualization where components are transformed, enabling each customer application to appear to run on a separate virtual machine. Generally, implementing a multi-tenant cloud architecture may have a production limitation, such as the failure of a single server instance 114 causes outages for all customers allocated to the single server instance 114. Accordingly, different redundancy techniques may be used to alleviate this potential issue. Embodiments of this disclosure are not limited to any particular implementation of cloud resource. Instead, the disclosed embodiments may function in a similar manner and share operation workload (e.g., operations) for a task flow between compute resources on a customer private network (e.g., 102) and a corresponding customer instance provided in cloud service provider network 110.

In another embodiment, one or more of the data centers 112 are configured using a multi-instance cloud architecture to provide every customer its own unique customer instance. For example, a multi-instance cloud architecture could provide each customer instance with its own dedicated application server and its own dedicated database server. In other examples, the multi-instance cloud architecture could deploy a single server instance 114 and/or other combinations of server instances 114, such as one or more dedicated web server instances, one or more dedicated application server instances, and one or more database server instances, for each customer instance. In a multi-instance cloud architecture, multiple customer instances could be installed on a single physical hardware server where each customer instance is allocated certain portions of the physical server resources, such as computing memory, storage, and processing power. By doing so, each customer instance has its own unique software stack that provides the benefit of data isolation, relatively less downtime for customers to access the cloud service provider network 110, and customer-driven upgrade schedules.

In one embodiment, utilizing a multi-instance cloud architecture, a customer instance may be configured to utilize a WaaS system (not shown in FIG. 1, see element 305 of FIG. 3) that creates and manages task definition and assignment and then may also create, save, update, manage, and/or execute flow plans incorporating a plurality of related tasks (or jobs). In particular, the WaaS system can create and update design-time flow plans and subsequently convert the design-time flow plan into a run-time flow plan for execution. As used herein, the term “design-time flow plan” refers to a flow plan built during the negotiation phase and prior to being converted (e.g., compiled) by a flow plan builder Application Programming Interface (API) to an execution phase. In one embodiment, the design-time flow plan contains one or more trigger instances, action instances, and step instances. A trigger instance refers to a process that initiates when a certain condition or event is met (e.g., a record matching a filter is changed, a timer expires, a new task is defined, or a work product is completed). An action instance refers to one or more step instances (e.g., a sequence of step instances) that processes some defined set of input values to generate a defined set of output values. The action instances can be linked together and with the trigger instance to form the design-time flow plan. During the flow plan execution phase, the automation system may execute a run-time version of the design-time flow plan (e.g., a task flow) using one or more flow engines. As used herein, the term “run-time flow plan,” or simply “task flow,” refers to a run-time engine implementation of a flow plan operating during execution phase and after being converted (e.g., compiled) by a flow plan builder API. FIG. 3, which is discussed in detail below, illustrates an example of a system (e.g., WaaS system) that may be used to create a design-time flow plan and then monitor execution of a run-time flow plan where work product is created.

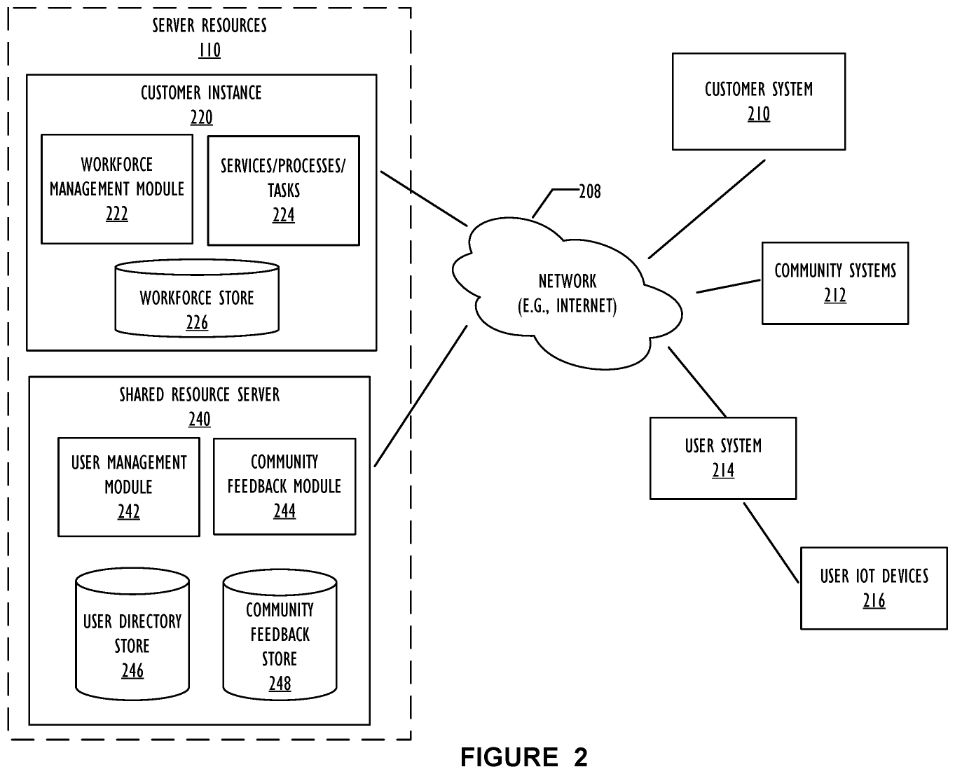

Referring now to FIG. 2, a network diagram for a WaaS system is illustrated. The network diagram illustrates various server resources 110 connected to various client devices across a network 208. In one or more embodiments, network 208 may be similar to network 108 described above with respect to FIG. 1. The various client devices may include a customer system 210, a community system 212, and a user system 214. The various client devices may be similar to devices 104 described above with respect to FIG. 1. In one or more embodiments, the customer system 210 may be a device from which a customer that utilizes a WaaS system through customer instance 220 within server resources 110. Community systems 212 may include one or more client devices from which members of the community may access server resources 110 over the network 208. User system 214 may include one or more client devices from which a user, such as a worker, may access the server resources 110. In one or more embodiments, user system 214 may include an enhanced user, such as an enhanced human. An enhanced human is a person that has technological enhancements which may be considered assets of the user. These technological enhancements may include, for example, enhanced strength, enhanced vision, technological implants, and the like. According to one or more embodiments, the technological enhancements may provide a network interface for the user to connect to the server resources 110 over the network 208. User system 214 may also be connected to user IOT devices 216, which may also be considered assets of a user. User IOT devices may be similar to edge IOT devices 105 described above with respect to FIG. 1.

Server resources 110, as depicted, includes customer instance 220 and shared resource server 240. Customer instance 220 and shared resource server 240 may be configured to communicate with each other in any suitable manner. For example, customer instance 220 and shared resource server 240 may communicate via a private local area network or via a public network such as the Internet. Customer instance 220 and shared resource server 240 may be provided on the same or on different data centers and/or server instances (e.g., same or different data centers 112, same or different server instances 114, and the like).

Customer instance 220 may provide applications and other modules for use by customer system 210 in one or more capability areas or enterprise units, such as IT, security, customer service, HR, finance, legal, marketing, sales, compliance, and governance. Further, as depicted, customer instance 220 may include services/processes/tasks 224. Services/processes/tasks 224 associated with customer instance 220 may represent various services, processes, or tasks (i.e., capabilities) of the enterprise that may be provided, managed, accessed, monitored, and the like by users or vendors of the enterprise through customer instance 220. Services/processes/tasks 224 may include services that users or vendors of the enterprise may actually use (e.g., email service, backup service, HR onboarding) and may need help with from, for example, IT or HR department of the enterprise; processes that may include methods by which the services of the enterprise are delivered to users; and functions that may represent different functions, units, or capability areas of the enterprise like IT, security, customer service, HR, finance, legal, marketing, sales, compliance, and the like. For purposes of this disclosure, the various services, processes and tasks may be referred to simply as tasks.

The various services/processes/tasks 224 may be completed by or assigned to machine or human resources within a workforce. In one or more embodiments, the customer instance 220 may include a workforce management module 222 by which a resource may be identified or requested for a particular task. The customer may manage a knowledge base of the various resources performing the various tasks utilizing the workforce store 226. In one or more embodiments, workforce store may manage a workforce for the customer. The workforce store may contain, for example, a database of attributes for each worker resource, such as human resources data and other data, including skills, benefits, geographic location, geographic location availability (e.g., restricted, unrestricted, virtual), pay information, products or services to which the worker was assigned, worker interests, worker purpose or mission, culture (e.g., cultures worker has experience with, culture with which the worker identifies). The workforce store 226 may also contain task metrics such as feedback from the customer, such as performance reviews, as well as community feedback (i.e., feedback received from third party community members knowledgeable about the product or service delivered by the worker on behalf of the customer). In addition, the workforce store 226 may also store feedback from the worker, or information or an indication regarding a worker's availability.

The customer, workers, and community members may also access shared resources of the server resources 110 through the shared resource server 240. Shared resource server 240 acts as a shared resource including data and application components available for multiple instances in server resources 110. Shared resource server 240 may include a user management module 242, a community feedback module 244, a user directory store 246, and a community feedback store 248. According to one or more embodiments, users of use system 214 may manage user accounts or profiles stored in user directory store 246 through the user management module 242. In one or more embodiments, the user may use the user profile to store such attributes as preferred companies to work for, preferred locations, preferred work types, current location, available locations, whether geographic location is restricted, or the user is available virtually. The user profile may also store attributes for the user such as communities to which the user belongs, skills, qualifications (e.g., education, certification, experience), available assets, work experience, interests, cultures with which the user is familiar or has experience with, compensation preferences, and multi-career information (i.e., information identifying more than one professional skill the user has). The user directory store 246 may also manage disclosure information, such as privacy information which indicates which entities are able to view certain information for the user profile. That is, a user may select to share or hide certain aspects of the user profile. Further, in one or more embodiments, the user may select to share or hide certain aspects of the user profile based on the requestor. For example, a user may wish to show certain attributes only to customers of a particular industry, within a certain geographic region, and the like. The user may also utilize the user directory store 246 to provide an indication of availability. In one or more embodiments, the user may indicate the availability in binary form (i.e., red or green light), by percentage of time available, hours per week, hours per month, days per month, or any other method for indicating availability. The user may also optionally provide indications for each community to which the user belongs, or professional skill provided by the user.

Members of the community may also access shared resource server 220 through community feedback module 246. According to one or more embodiments, the community members may provide feedback regarding a skill or product provided by a user. The feedback may include attributes about the user. The feedback may include, for example, rankings among users in a community, standings or skill of a user (i.e., novice, proficient, advanced, expert; apprentice, master, guru, god). The community feedback store may also include attributes about the user such as attraction, worth, and soft skills (assimilation, teamwork, and the like). In one or more embodiments, the community feedback store may also provide additional information based on aggregate data provided by the community. For example, an attraction score may increase as customers request the user, or a standing or skill of a user may increase or decrease based on aggregate community feedback. According to one or more embodiments, aggregate community feedback may require a threshold number of community feedback records in order to have an impact on the user feedback score. It should be noted that the various attributes described above with respect to each of the workforce store 226, user directory store 246, and the community feedback store 248 may be used throughout each of the other databases. In addition, the various attributes discussed above are merely some examples and additional attributes may be used.

According to one or more embodiments, a customer may submit a request for candidate users to the workforce management module 222 of customer instance 220. The request may include a query that includes request parameters. The request parameters may reflect required or preferred attributes of the user. According to one or more embodiments, the request may be generated automatically, for example, based on a job or task availability by the customer. In one or more embodiments, the workforce management module may process the query to identify a first plurality of users from one or both of the workforce store 226 and the user directory store 246 based on the request parameters. The first plurality of users may be refined to obtain a list of candidate users based on community metrics from the community feedback store 248. Thus, for example, the candidate list may be further limited to users for which community feedback satisfies particular requirements. Alternatively, or in addition, the plurality of users may be refined by ordering the list based on a best match for the query, or based on the use attributes and/or community feedback. As an example, two otherwise identical candidates may be listed based on a community-provided skill level or level of attractiveness. The candidate list may then be transferred to the customer system 210.

According to one or more embodiments, a suggested rate may be determined for candidates in the candidate list based on a particular task and how close of a match the user is for the request. In one or more embodiments, the suggested rate may be based, at least in part, on a suggested rate provided by a user in the user directory store 246, and optionally based on a comparison of a particular candidate user among other candidate users.

Referring now to FIG. 3, where a block diagram 300 illustrates different entities and how their interactions may be coordinated in an automated task-scheduling system, according to one or more disclosed embodiments. Block 305 represents a centralized schedule and tracking system to support an example implementation of a WaaS system including multiple dashboards and peer group inputs 315. The centralized schedule and tracking system 305 may be implemented in a customer instance of a cloud service provider, for example. Centralized schedule and tracking system 305 may be responsible for functions designed to support data security, privacy, and integrity of information. Conceptually, centralized schedule and tracking system 305 may be thought of as a Configuration Management Data Base (CMDB) that includes attributes of configuration items (CIs) and represents human resources as if they were CIs.

Block 310 represents a resource interface which may be implemented, for example, as a dashboard. The resource may be human or machine and represents a worker (e.g., compute resource, professional resource (e.g., programmer)) that may receive a dispatched task and return a work product (e.g., compute results, source code application). As mentioned above, a group of tasks may be processed and referred to as a job for which status tracking and dispatching are performed as a single unit (e.g., job treated as a single composite task). Block 311 represents inputs that may be provided about a worker. For a compute resource, these inputs may include processor type, memory, etc. For a human resource, the inputs may include individual data about the human resource. Details of individual data will be discussed below. Block 312 represents outputs from centralized schedule and tracking system 305 that may be provided to a resource, for example via a dashboard for interaction with the human resource. Outputs for a compute resource may include an alert about a new task, a request for a status of a current task, etc. Outputs for human resources may include, a rating, experience information, compensation information, alert about a new task, etc. In general these outputs may be information to advertise a new task, track status of a current task, or provide information about how the human resource is perceived with respect to its work product.

Blocks 315 represent multiple communities, such as peer groups, that may provide subjective measurements about workers, for example through community feedback module 244. A community of like individuals may cross-rank each other based on skills and previous work-related and other interactions. For example, a speaker at a technical conference may receive rankings from attendees at that conference (e.g., peer rankings input 316). People that have worked together may rank other individuals that they have experience with. Further, people that are not necessarily peers but that have knowledge of a product or service provided by a user, may rank or provide feedback. As explained below, subjective rankings may be subject to bias and, therefore, disclosed implementations include methods and processes to increase the integrity of subjective measurements. Further, disclosed implementations may create and maintain objective measures about human resources that are derived from actual real-world facts and, therefore, unless some unusual circumstances exist, represent highly accurate metrics with respect to a human resource. Block 317 indicates that a group of peers may also provide corporate rankings that may provide an indication of its experience when performing a task for that customer corporation. For example, if the task was well defined, if the task was well managed, and if compensation was paid on time, the corporation may receive a high ranking. However, if the task was not managed well or if the experience of the human resource was not positive, then the corporation may receive a low ranking. Human resources may utilize a corporate ranking when determining whether to make themselves available to perform a task such that client corporations may want to maintain a high ranking in order to attract selective workers.

Block 320 represents a corporate input mechanism such as a corporate dashboard. In general, the corporation may be thought of as the task requestor (even though this may come, in some cases, from a project manager 325) as well as the recipient of candidate users and work product results. Block 321 represents inputs that may come from a corporation, such as a task definition and a budget associated with a completed work product. Block 325 represents a project manager input/output interface, e.g., dashboard, which may be used by a project manager to interface with centralized schedule and tracking system 305. In one embodiment, a project manager may be thought of as closely related to a corporation as a manager of tasks for that corporation. Clearly, a human resource skilled in project management may perform that service, as part of this disclosed system, for more than one corporation simultaneously. Block 326 represents information that may be exchanged between a project management dashboard 325 and centralized schedule and tracking system 305. This information may include a task definition query to identify potential resources 310 that may be used to produce a work product. Additionally, any negotiation of a work agreement, tracking of work assignments, and resource completion metrics may be provided or augmented by project manager 325. At the completion of a work project, project manager 325 may provide feedback similar to a “performance review” that may be used in a similar manner as peer rankings discussed above. That is, a performance review may represent a subjective measurement that may be used as part of an overall assessment of a resource.

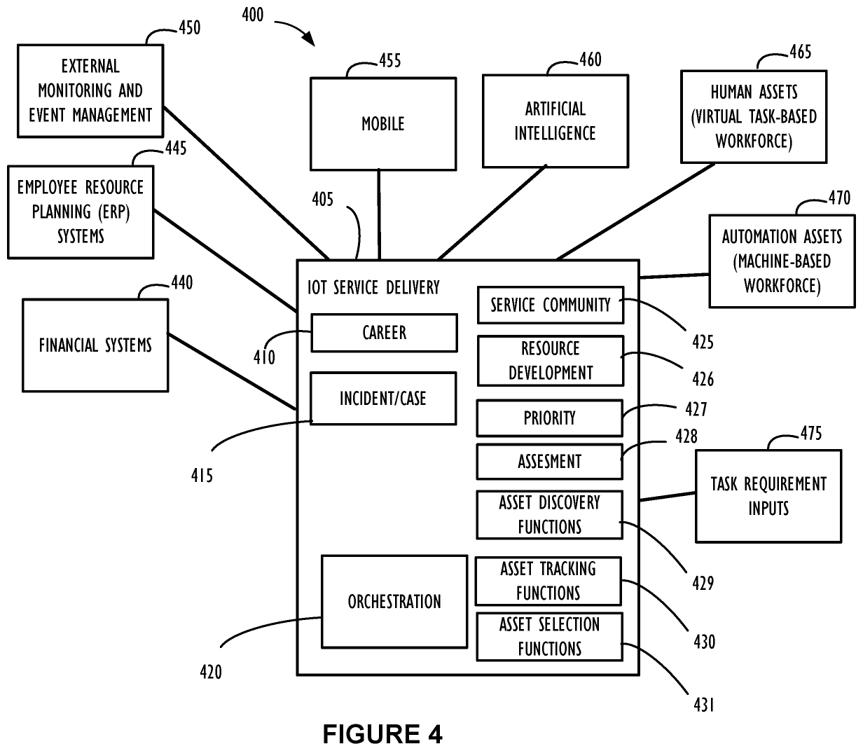

Referring now to FIG. 4, block diagram 400 represents a second example of different entities and associated metrics with respect to how their interactions may be coordinated in an automated task-scheduling system, according to one or more disclosed embodiments. The central block of block diagram 400 represents an IOT service delivery function 405 that may be implemented as part of a customer instance in network infrastructure 100. Block 410 indicates that IOT service delivery function 405 may include a career module. A career module 410 may track information regarding a human resource to provide a career path with respect to tracking and training that resource. Block 415 indicates that IOT service delivery function 405 may include an incident/case management system. The incident/case management system 415 represents an example of how WaaS functions may be integrated with standard service functions provided for an enterprise.

Block 420 indicates that an orchestration system may also be provided. An orchestration system 420 may be configured to stitch together software and hardware components to deliver a defined service. For example, connecting and automating workflows as applicable to deliver a defined service. Block 425 represents that information, representative of a service community (e.g., peer group of like individuals), may be stored in IOT service delivery function 405. Block 426 represents a resource development function that may be used to assist career module 410 mentioned above. Block 427 represents that IOT service delivery function 405 may assign a priority to dispatched tasks and work items as part of a work flow automation function. Block 428 indicates that assessment (e.g., peer review, performance review) information may be maintained in IOT service delivery function 405. Block 429 represents an asset discovery function that may be used to identify potential resources (both human and machine) to service particular tasks. Block 430 represents an asset tracking function and block 431 represents an asset selection function. The asset tracking function 430 and asset selection function 431 may be used, for example, by project manager 325 of FIG. 3.

FIG. 4 also shows components, modules, and assets that may interface with (e.g., be remotely connected to) IOT service delivery function 405. Block 440 represents that financial systems may be connected. Block 445 indicates that an employee resource planning (ERP) system may be connected. Block 450 indicates that external monitoring and event management may interface with IOT service delivery function 405. Block 455 indicates that interfaces may be mobile such that human resources may interact with IOT service delivery function 405 from laptops, smartphones, etc. as necessary. Block 460 indicates that artificial intelligence (e.g., machine learning techniques) may be utilized with IOT service delivery function 405. Block 465 indicates that human assets (for example a virtual task-based workforce providing WaaS) may be interfaced with IOT service delivery function 405. Block 470 indicates that automation assets (e.g., machine-based workforce) may be interfaced with IOT service delivery function 405. Finally, block 475 represents that task requirement definitions, e.g., from a corporation or project manager, may be input into IOT service delivery function 405. Note, the depiction of functions and locations of those functions with respect to IOT service delivery function 405 is for example purposes only. In certain implementations, boxes shown outside of IOT service delivery function 405 may be implemented as internal functions and functions illustrated as being integrated into IOT service delivery function 405 may be implemented as external functions. These types of implementation decisions can be made based on design criteria of a particular implementation of the disclosed centralized schedule and tracking system (e.g., 305 of FIG. 3).

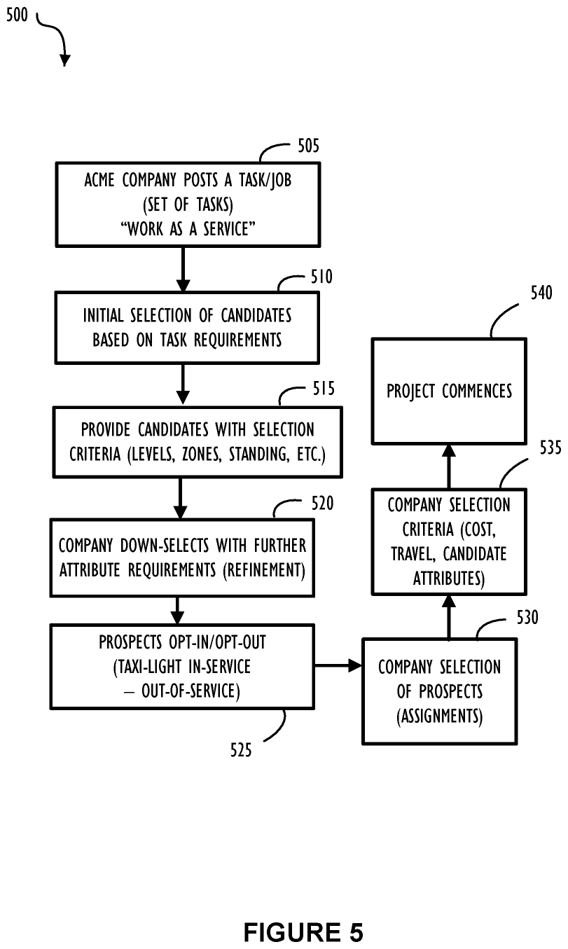

Referring now to FIG. 5, flow chart 500 illustrates one possible flow from the perspective of a company, according to one or more disclosed embodiments. Beginning at block 505, “ACME” company posts a task to be completed as a work product in a WaaS system. Block 510 indicates that an initial selection of candidates may be performed, e.g., by project manager 325 of FIG. 3, based on a match of the candidate users (e.g., human resources) to task requirements. Block 515 indicates that selection criteria identifying applicable or preferred candidates may include levels of skill, zones to correlate with work hours, standing within a peer community, etc. Block 520 indicates that a representative of ACME Company (again may be project manager 325) may refine the number of candidates based on further selection criteria. Block 525 indicates that potential candidates may provide an opt-in/opt-out status to indicate their availability to perform certain tasks. This may be thought of as a “Taxi-light” feature where the Taxi-light indicates in-service or out-of-service with respect to wanting to take on more work. Block 530 indicates that company selection of candidates may be performed and assignments may be made. Block 535 indicates that final company selection criteria may include factors such as cost, travel requirements, and candidate attributes, to name a few. Finally, block 540 indicates that a project may begin and resources may be tracked to ensure that work product to satisfy requirements arrives on schedule.

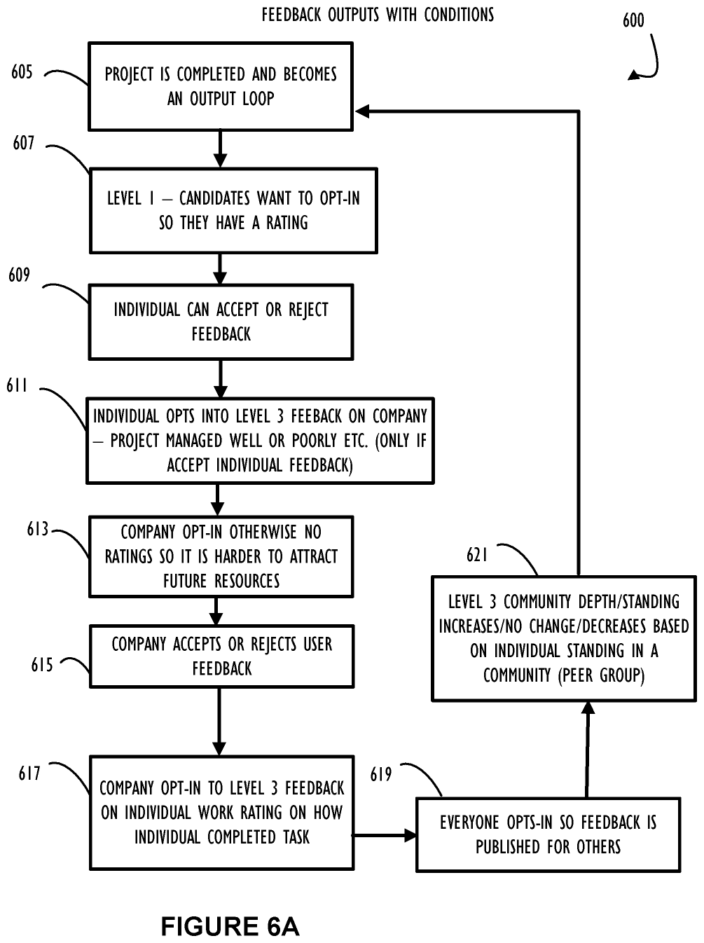

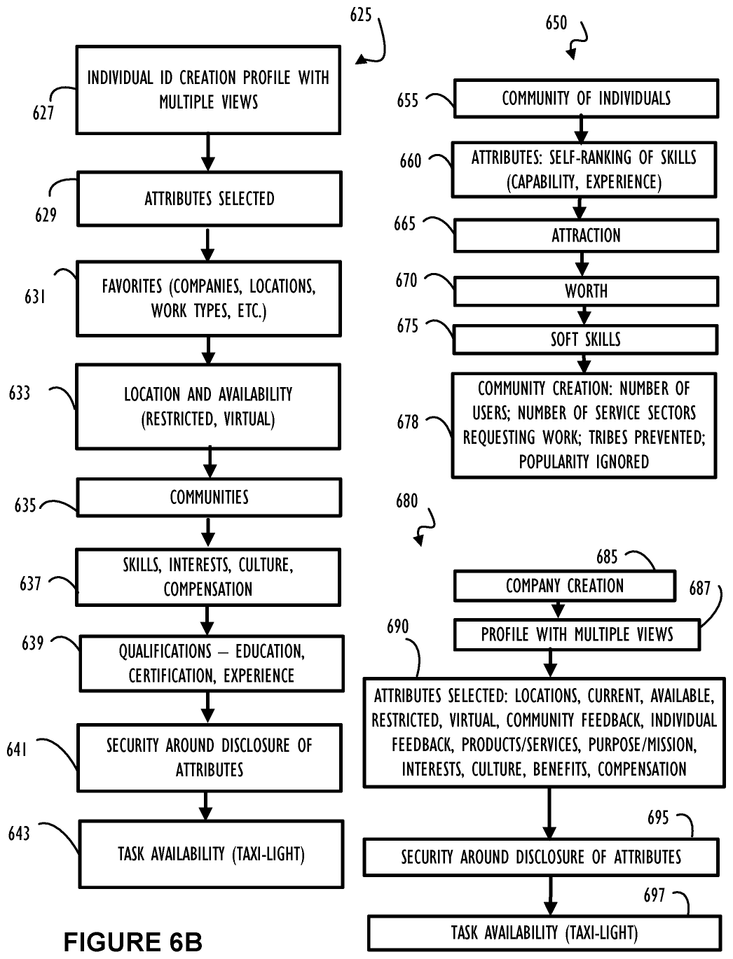

FIG. 6A illustrates a flow chart 600 of one possible feedback loop for use in maintaining subjective measurements, according to one or more disclosed embodiments. Beginning at block 605 a project is completed and may transition from active monitoring to post-processing functions. That is, the work product has been reviewed and accepted based on some measurement of conformance to requirements, for example. Block 607 indicates that at level 1, a candidate (i.e., the human resource providing the work product) can opt-in to participate in a feedback process regarding this work effort (block 609). According to one or more embodiments, if a selected candidate opts-in, they are allowed to provide feedback at later stages, otherwise, they may be prohibited from sharing feedback about this particular work effort. As will become clear, in some implementations, both the resource and the corporation must opt-in to create feedback that is publicly available (e.g., in the user directory store 246). In general, resources may desire to opt-in to feedback loops to increase their rankings and status with respect to future work effort assignments. Block 611 indicates that an individual may opt-in to provide level 3 feedback on the company as to how the company presented itself in this work effort. Block 613 indicates that a company may also opt-in so that it may receive a ranking and attract future prospects based on a high ranking. Block 615 indicates that a company can then accept or reject feedback as provided by the resource. Block 617 indicates that if all parties have opt-in status for preceding steps, the company may provide feedback on the resource. Block 619 indicates that, in this example, all parties have opted-in to all levels and feedback from all parties may be published. Block 621 indicates that a level 3 community ranking and standing for an individual may be adjusted based on this published feedback. Similarly, a company's ranking may be adjusted. Flow then returns to block 605 where a second completed project (or work task) may be processed for feedback. In general, the system may be configured to encourage feedback and rankings to increase the value of subjective measurements with respect to task assignment (e.g., increase the accuracy of the subjective data).

FIG. 6B illustrates three flow charts 625, 650, and 680 from a perspective of an individual resource, community of individuals, and company, respectively, according to one or more disclosed embodiments. From the perspective of an individual, flow chart 615 shows, at block 627, that an individual may create an identity profile with multiple views. For example, a human resource may have many different sets of skills that may be treated individually or viewed selectively based on attributes of the requestor. Block 629 indicates that the individual may select attributes to describe its capabilities and availability to perform WaaS services. Block 631 indicates that a user may provide favorites or preferences. Block 633 indicates that a user may provide location and availability information and restrict its visibility to certain types of work efforts (e.g., remote or only for certain companies). Block 635 indicates that a user may associate its profile with one or more communities (e.g., peer groups of individuals with similar skills). Block 637 indicates that sills, interests, culture, and compensation preferences/requirements may be defined. Block 639 indicates that a user may provide information about qualifications with respect to work product requests. In some implementations, this information may be validated against external sources of information by, for example, verifying the user has a law license in a certain jurisdiction as claimed. Block 641 indicates there may be security and privacy settings so that profile information is shared on a need-to-know basis rather than publicly broadcast. Block 643 indicates that a user may have a Taxi-light attribute to turn on and off their visibility for tasks within different time periods.

From the perspective of the community of individuals (e.g., peer groups), flow chart 650 shows, at block 655, where a community of individuals may be created. Block 660 indicates that attributes of members of this community (e.g., self-described skills) may be collected and correlated across members of the groups. Block 665 indicates that one purpose of these attributes is to attract requests for work product. Block 670 indicates that peer group members may have a relative worth within the community (e.g., apprentice or guru). Block 675 indicates that the community may include a measurement of soft skills (e.g., personal interaction skills) for peer group members. Block 678 indicates that measurements within a peer group may include attributes of individuals and the group as a whole. Formation of subjective measurements that are biased toward popularity or formation of “tribes” within the peer group may be discouraged to increase accuracy of subjective measurements.

From the perspective of the company, flow chart 680 shows, at block 685, where a company may create a company profile. Block 687 indicates that a company profile may have multiple views. Block 690 indicates that attributes of the company may be populated to provide information about the company to prospective human resources participating in a WaaS system. Block 695 indicates that these attributes may be subject to security restrictions and need-to-know access rather than publicly broadcast. Block 685 indicates that a company profile may also have a taxi-light type indicator to provide information as to availability of WaaS service requests that are outstanding.

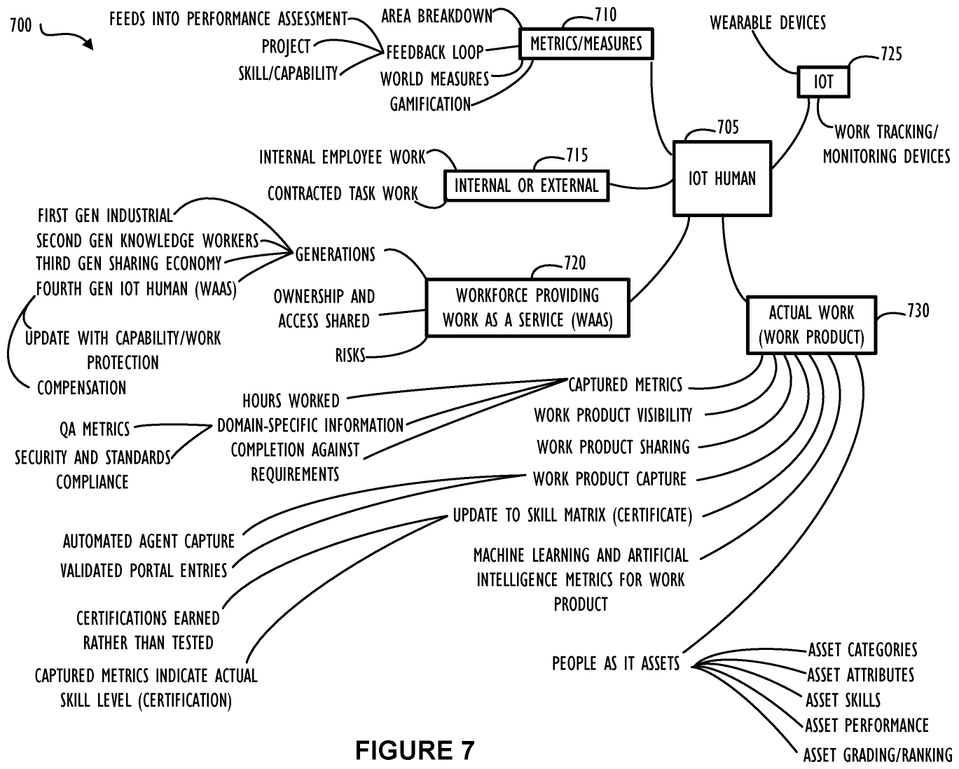

FIG. 7 illustrates possible attributes of items that may be tracked in accordance with one or more disclosed embodiments. Block 705 is centrally located in diagram 700 and represents an IOT resource that may be a human resource. Block 705 has connections to illustrative areas of input and tracking for a human resource as an IT asset, which may be conceptually thought of as an IOT HUMAN. Connections to attributes that may be used to determine proper associations of human resources with work product requests in a WaaS system include attributes to track, for example: metrics and measures (710), internal or external human resources (715), work as a service tasks (720), IOT sensors associated with (e.g., embedded in) a human resource (725), and work product (730). Block 710 indicates that different types of metrics and measures may be collected and maintained for each human resource. For example, the technical abilities of the resource, the ability of the resource to work in a group, the ability of the resource to complete work in a timely fashion, and the leadership abilities of the resource may all be collected. Block 715 indicates that a human resource may be internal to an organization (e.g., full-time or part-time employee) or external to an organization (e.g., contractor-style relationship). Block 720 indicates that WaaS factors, such as availability, location, language ability, and standing in peer group, may be tracked as part of some example implementations. Block 730 indicates that work product may be tracked as part of the WaaS system to produce, for example, objective measurements that are not subject to artificial bias. Examples of objective measurements include difficulty of task, time to complete task, completeness of task, correctness of task. Block 725 indicates that a human or machine resource may be monitored as an IOT device with sensor inputs. For example, the human resource may be augmented with a device that tracks fitness for duty, or attention span. Wearables or implants could augment a human's physical abilities to extend endurance, increase attention span, or reduce the time to reference materials externally. This capability, when coupled with platform based AI may be used to predict performance drop off and may recommend rest period or replacement of the human resource. This may provide an additional value and schedule metric with respect to determining work duration per human resource.

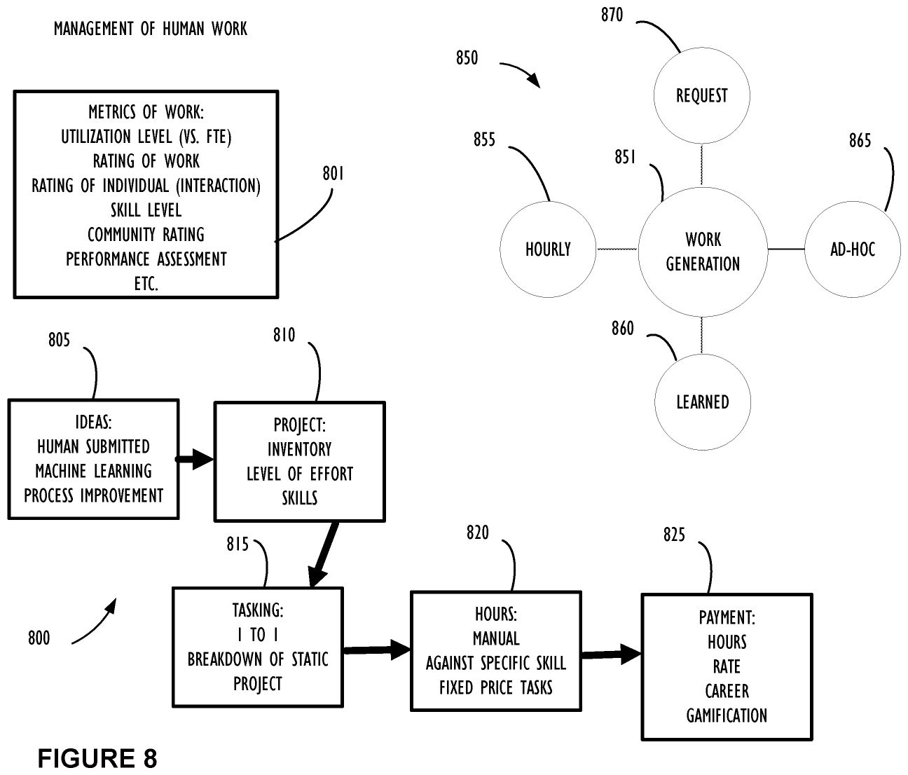

FIG. 8 illustrates one possible process flow 800 and human work generation relationship diagram 850 that may be useful for managing human work, according to one or more disclosed embodiments. Block 801 indicates that metrics of work for a human may include utilization level, such that a contractor, rather than a full-time employee (FTE), may be better aligned with a given work task in a WaaS system. A human work task may also have a rating level that may be matched with a skill level, for example, of a human resource. Individuals may have an interaction rating as to how well they interact with others in their peer group which may be useful when a team versus individual work item is under consideration for dispatching or assigning. In addition to an individual skill level, the disclosed WaaS system may incorporate a community ranking to represent how a particular individual is viewed (and rated) by other members of a peer group. A performance assessment may also be subjectively and objectively determined and maintained by the WaaS system. For example, feedback information, as described above, and quality metrics may be gathered and maintained for each work item.

As mentioned above, subjective measurements differ from objective measurements in that subjective measurements may be provided with a degree of potential bias whereas objective measurements of this system may be actual measurements of time taken to complete a task, compensation per task, actual number of defects reported in work product prior to acceptance and post production. In this instance, prior to acceptance refers to the time period when a work product is being evaluated for acceptance with respect to its defined completion criteria and post production refers to a continued tracking and association of a portion of a product released to end-users by a corporation, for example. In this manner, a metric associated with the overall robustness of a work product may be determined. For example, was the work product merely robust enough to pass internal audit or was the work product robust enough to perform at a high level in production and not cause delayed cost for a corporation.

As will be recognized by one of ordinary skill in the art of software programming, some developers may produce code that strictly satisfies requirements and performs well in a test environment but fails in a real-world deployment. Others create a more general programming solution that stands up to unexpected situations without failure. By tracking and associating work product in a WaaS system for an extended lifecycle a measure of competence of the human resource may be objectively measured.

One aspect of a WaaS system as disclosed, is the gamification of work product and task completion with respect to peers. For example, a system may be implemented to allow visibility and competition amongst different human resources. Competitive human resources may work harder to achieve certain goals and rewards in addition to standard monetary compensation. The ability to include status ranking as an element of compensation, and the ability to increase status ranking as more and progressively more difficult tasks (work) are accomplished provide additional incentives to human resources. This may result in increased desirability of future “employers” to have a particular human resource on the “team.” There are many elements that may be included in this status ranking “gamification or score-keeping” system, which include, but are not limited to, technical ability, social ability, perception, timeliness, certifications, awards, and peer recognition for challenging accomplishments.

Returning to FIG. 8, process 800 shows, at block 805, where an idea may be entered into the WaaS system. Ideas may come from different sources, including a standard manually-entered task, a task identified as desirable by machine learning, or a process improvement task identified by a resource bottleneck in a work flow, for example. Block 810 indicates that a project may be defined and may include an inventory of resources required, a level of effort (e.g., budget) required, and skill requirements. Block 815 indicates that project tasking may take place to identify component work tasks to satisfy an overall project plan. Block 820 indicates that a project may be broken down for analysis (or scheduling) based on hours to complete tasks and associate specific tasks based on skills, budgeting criteria, or both. Finally, block 825 indicates that a payment system may be configured to provide “payment” or compensation to human resources providing a work product result to the project. Payment may be monetary, based on hours at a given rate or a fixed fee, a career advancement, and/or game skill points to increase a resource's status rating. For example, some tasks may be performed for no monetary compensation by a human resource in order for that human resource to attain a particular skill level (e.g., un-paid apprentice, training, etc.).

Diagram 850 illustrates the relationship between work generation 851, hourly work 855, learned tasks 860 (e.g., tasks identified by machine learning), ad-hoc tasks 865 (e.g., one-off tasks that may stand alone and may not be associated with a larger project plan), and traditional task requests 870. In general, there may be many possible ways to initiate completion of a work product (e.g., work generation) directed to a human non-machine resource rather than a machine resource in the disclosed WaaS system.

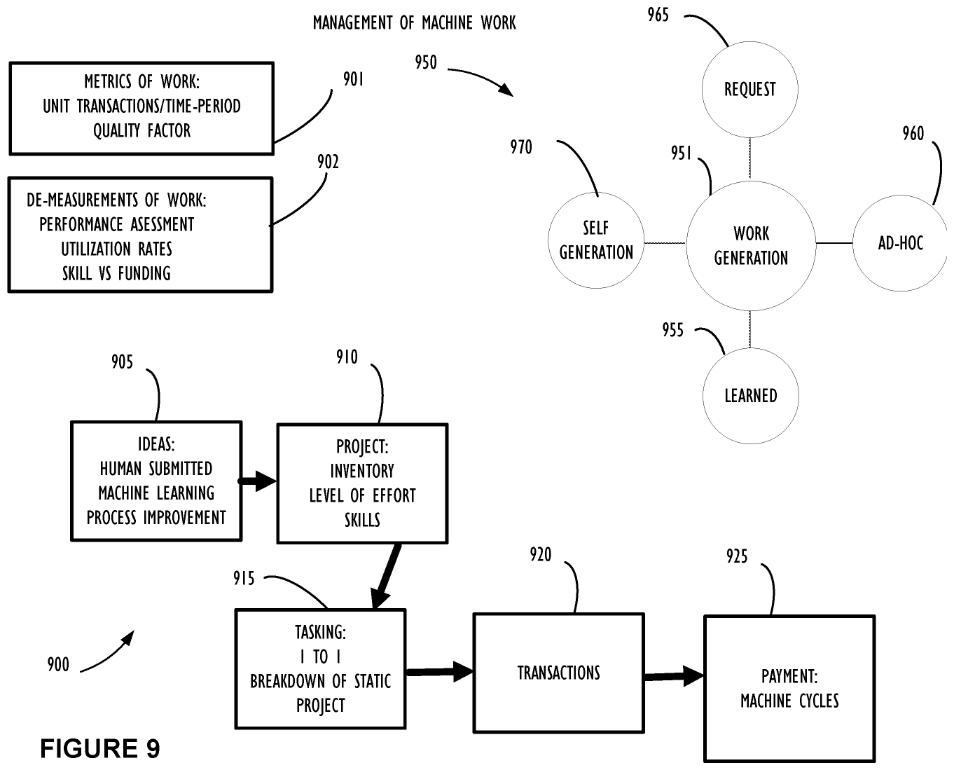

FIG. 9 is similar to FIG. 8 except that instead of illustrating human tasks, it illustrates one possible process for managing machine (i.e., automated) work, according to one or more disclosed embodiments. Although, FIGS. 8 and 9 are shown as separate figures in this disclosure, it is intended that there will exist hybrid work product requests that may be completed by a combination of human resources and machine resources. The disclosed WaaS system may include algorithms, for example, based on machine learning, to optimally divide work product requests into portions automatically prepared and portions prepared with human involvement. Block 901 indicates that metrics of work for a machine may include unit transactions per time period (e.g., compute capacity) and a quality factor (e.g., how well the machine may perform the task alone or with a degree of human assistance). Block 902 indicates that de-measurements of work may include performance assessment, utilization rates, and skills versus funding. Each of these criteria may be used to determine if a human resource may be better suited to perform the task as opposed to a fully automated resource.

Process 900 is similar to process 800, with block 905 indicating that, in some embodiments, ideas begin a work product request, a project may be created at block 910, and tasking may take place at block 915. Block 920 indicates that transactions may be measured for fully automated tasks and block 925 indicates that compensation (e.g., payment) for a machine-implemented tasks may be based on the compute resources used. For example, machine cycles billed in a mainframe environment or cloud-based resources used for a period of time. Diagram 950 indicates that machine work product generation may be similar to the human work product generation (see discussion of FIG. 8 above) (in some cases may be identical) as indicated by learned 955, ad-hoc 960, and request 965. However, a self-generation 970 of a work product may exist for a machine. For example, when a machine divides a work product request into component parts for distributed processing.

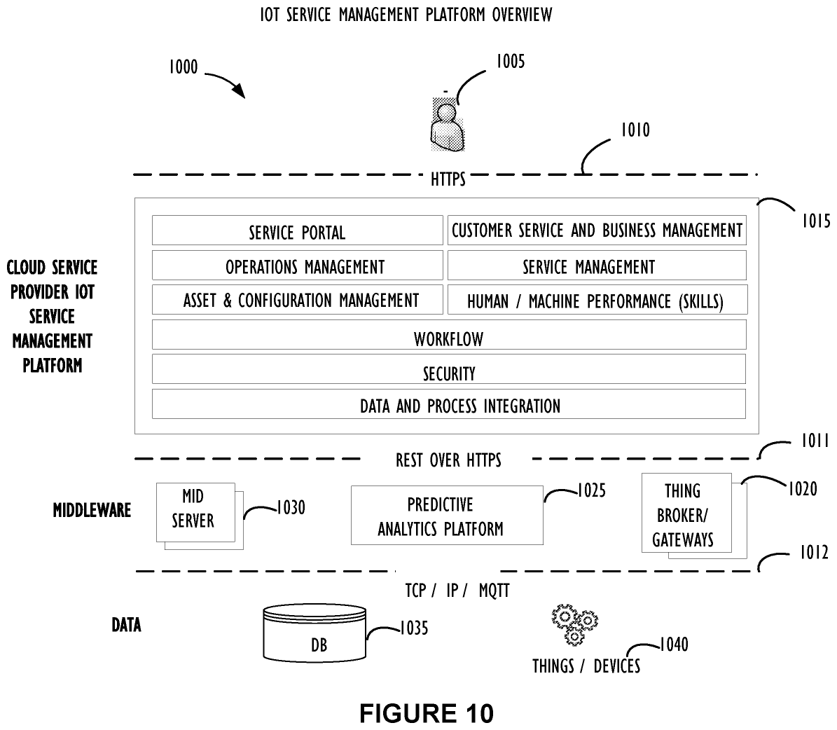

FIG. 10 illustrates an overview of a possible Service Management Platform (SMP) 1000, according to one or more disclosed embodiments. For example, SMP 1000 may represent an embodiment of a WaaS system as implemented according to one or more disclosed embodiments. Human 1005 may interact with SMP 1000 using a web-based interface communicating via an HTTPS 1010 protocol. Block 1015 illustrates that a cloud service provider infrastructure may be used to implement the SMP 1000. Dashed line 1011 illustrates that a REST protocol over HTTPS may be used to interface middleware components (e.g., MID server 1030, Predictive Analytics Platform 1025, and Thing broker/gateways 1020 to the cloud-based portion of SMP 1000. Line 1012 indicates that different protocols (e.g., TCP, IP, or Message Queuing Telemetry Transport (MQTT)) may be used to communicate to data stores, such as database 1035 or things/devices 1040 that make up the IOT. SMP 1000 illustrates that many different component parts may be interconnected to support an implementation of WaaS where human resources may be considered components or “things” within the IOT.

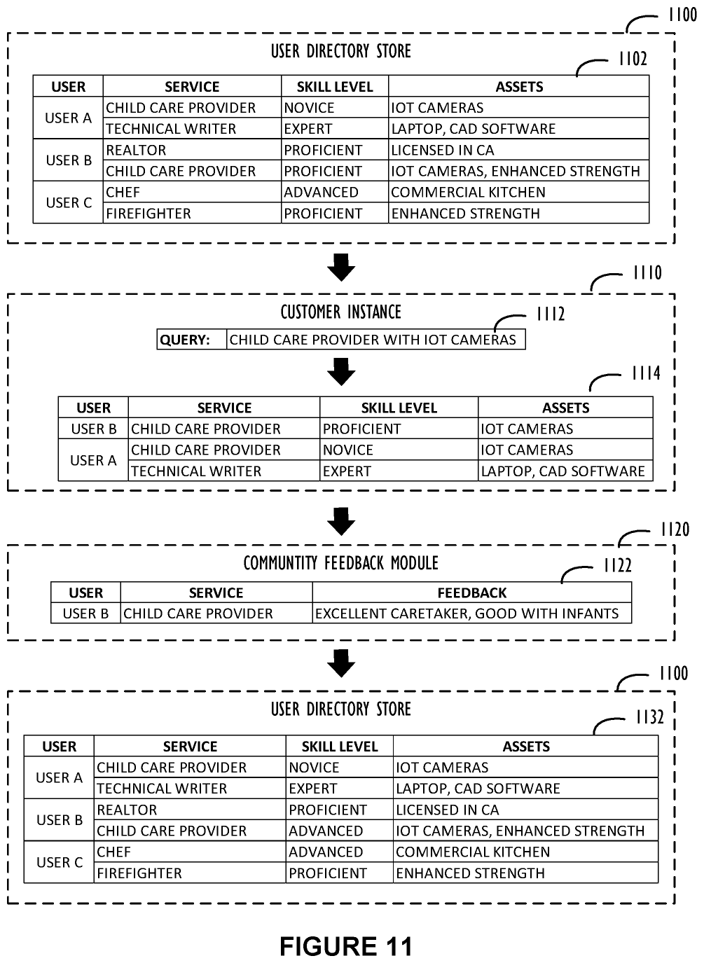

FIG. 11 illustrates an example flow diagram of various actions among the network infrastructure. The flow begins with an initial version of user directory 1102. The various entries shown in user directory 1102 are merely for example. It should be understood that different categories of attributes may be included in the user directory. The user directory may be stored in a user directory store 1100. The initial user directory 1102 shows three example users, each with a variety of attributes. User A is shown as providing two different services: child care provider and technical writer. These services may be indicative of the communities to which User A belongs. For each provided service, User A has additional attributes. As shown, with respect to a child care provider view of User A's profile, the profile indicates that User A has IOT cameras. With respect to a technical writer view of User A's profile, the profile indicates that User A has a laptop and CAD software. The user directory 1102 also includes metrics provided by community users. In this example, the metrics indicate a skill level for each view. As described above, the community metrics may be crowd sourced such that multiple community users' input are utilized to generate a particular attribute. In this instance, the child care provider view of User A's profile indicates that User A's skill level is Novice, while the technical writer view indicates that User A's skill level is expert. In one or more embodiments, certain attributes may be provided by the user, or may be determined based on feedback, such as feedback from the community and/or feedback from the customer. User B is shown as providing two different services: realtor and child care provider. With respect to a realtor view of User B's profile, the profile indicates that User B is licensed in California. As shown, with respect to a child care provider view of User B's profile, the profile indicates that User A has IOT cameras and has enhanced strength. Both the child care provider view and the realtor view of User B's profile indicates that User B's skill level is Proficient. User C is shown as providing two different services: chef and fire fighter. With respect to a chef view of User C's profile, the profile indicates that User C has a commercial kitchen. As shown, with respect to a firefighter view of User C's profile, the profile indicates that User C has enhanced strength. User C is depicted as having an advanced skill level in the chef view, and a proficient skill level in the firefighter view.

The flow diagram continues when a query 1112 is entered at a customer instance 1110. In one or more embodiments, a customer may request a list of candidate user workers by submitting a query. Alternatively, or additionally, the query may be generated at least partially automatically based on an identified need by the customer instance. The query may be entered, for example, into a workforce management module, such as workforce management module 222 of FIG. 2. For purposes of this example, the customer requests a child care provider with IOT cameras. Returning to the example of FIG. 2, the workforce management module may pull records from any of workforce store 226, user directory store 246, and community feedback store 248 to generate and refine a list of candidate users 1114. The list of candidate users shows user records from user directory store 246, which may be enhanced, or previously generated, based on data from community feedback store 248. As shown, the view of the various user records may differ based on user-defined parameters. That is, User B has selected that non-related views not be shown to a requestor. Thus, the candidate list 1114 only shows the child care provider view of User B's profile. By contrast, the candidate list 1114 shows both the child care provider view and the additional technical writer view for User A. Users may vary how their profiles are viewed in other ways. For example, as depicted, the child care provider view of User B also does not show that User B has enhanced strength. The user can select certain attributes to hide under various circumstances, such as a type of requestor, a type of task, and the like. As shown, User B is listed above User A. In one or more embodiments, candidate users may be listed, at least in part, based on a skill level, which may be crowd sourced from a community. Thus, User B is listed above User A because User B has a proficient skill level for the child care provider service, whereas User A has a novice skill level for the child care provider service. According to one or more embodiments, a candidate user may alternatively, or additionally, be automatically selected and assigned a particular task.

According to one or more embodiments, the customer may select a candidate user as a worker, and assign that candidate user the task. Feedback may be collected and managed from various sources based on the work product or service delivered by the selected candidate. As shown, community feedback module 1120 may be used to collect feedback from community members regarding the selected candidate's work. The example community feedback 1122 shows that User B's service from a community member indicates “excellent caretaker, good with infants.” According to one or more embodiments, the community feedback may be fed back into the user directory such that a user's skill level is increased or decreased based on the feedback. As shown, User B's skill level in the second version of the user directory 1132 indicates that the skill level is now “Advanced.” Although not shown, the customer may also retain feedback regarding the user in workforce store 226. In some embodiments, the feedback from the customer regarding the user may also be fed back into the user directory 1132.

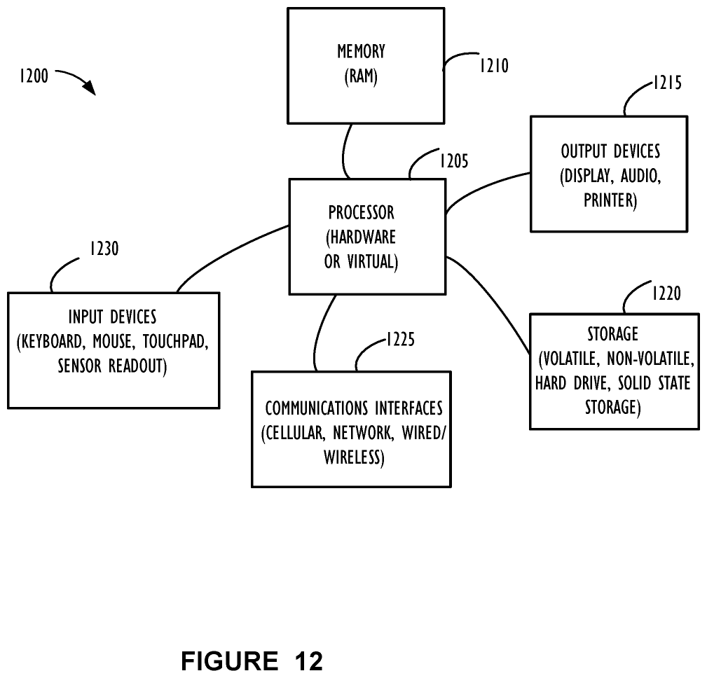

FIG. 12 illustrates a block diagram of a computing device 1200 that may be used to implement one or more disclosed embodiments (e.g., network infrastructure 100, client devices 104A-104E, compute resources 106A-106C, etc.). For example, computing device 1200 could represent a client device or a physical server device and could include either hardware or virtual processor(s) depending on the level of abstraction of the computing device. In some instances (without abstraction), computing device 1200 and its elements, as shown in FIG. 12, each relate to physical hardware. Alternatively, in some instances one, more, or all of the elements could be implemented using emulators or virtual machines as levels of abstraction. In any case, no matter how many levels of abstraction away from the physical hardware, computing device 1200 at its lowest level may be implemented on physical hardware. As also shown in FIG. 12, computing device 1200 may include one or more input devices 1230, such as a keyboard, mouse, touchpad, or sensor readout (e.g., biometric scanner) and one or more output devices 1215, such as displays, speakers for audio, or printers. Some devices may be configured as input/output devices also (e.g., a network interface or touchscreen display). Computing device 1200 may also include communications interfaces 1225, such as a network communication unit that could include a wired communication component and/or a wireless communication component, which may be communicatively coupled to processor 1205. The network communication unit may utilize any of a variety of proprietary or standardized network protocols, such as Ethernet, TCP/IP, to name a few of many protocols, to effect communications between devices. Network communication units may also comprise one or more transceiver(s) that utilize the Ethernet, power line communication (PLC), WiFi, cellular, and/or other communication methods.

As illustrated in FIG. 12, computing device 1200 includes a processing element, such as processor 1205, that contains one or more hardware processors, where each hardware processor may have a single or multiple processor core(s). In one embodiment, the processor 1205 may include at least one shared cache that stores data (e.g., computing instructions) that are utilized by one or more other components of processor 205. For example, the shared cache may be locally cached data stored in a memory for faster access by components of the processing elements that make up processor 1205. In one or more embodiments, the shared cache may include one or more mid-level caches, such as level 2 (L2), level 3 (L3), level 4 (L4), other levels of cache, a last level cache (LLC), or combinations thereof. Examples of processors include, but are not limited to, a central processing unit (CPU) and a microprocessor. Although not illustrated in FIG. 12, the processing elements that make up processor 1205 may also include one or more other types of hardware processing components, such as graphics processing units (GPU), application specific integrated circuits (ASICs), field-programmable gate arrays (FPGAs), and/or digital signal processors (DSPs).

FIG. 12 illustrates that memory 1210 may be operatively and communicatively coupled to processor 1205. Memory 1210 may be a non-transitory medium configured to store various types of data. For example, memory 1210 may include one or more storage devices 1220 that comprise one or more non-volatile storage device(s) and/or volatile memory. Volatile memory, such as random access memory (RAM), can be any suitable non-permanent storage device. The non-volatile storage device(s) 1220 can include one or more disk drives, optical drives, solid-state drives (SSDs), tap drives, flash memory, read only memory (ROM), and/or any other type of memory designed to maintain data for a duration after a power loss or shut down operation. In certain instances, the non-volatile storage device(s) 1220 may be used to store overflow data if allocated RAM is not large enough to hold all working data. The non-volatile storage device(s) 1220 may also be used to store programs that are loaded into the RAM when such programs are selected for execution.

Persons of ordinary skill in the art are aware that software programs may be developed, encoded, and compiled in a variety of computing languages for a variety software platforms and/or operating systems and subsequently loaded and executed by processor 1205. In one embodiment, the compiling process of the software program may transform program code written in a programming language to another computer language such that the processor 1205 is able to execute the programming code. For example, the compiling process of the software program may generate an executable program that provides encoded instructions (e.g., machine code instructions) for processor 1205 to accomplish specific, non-generic, particular computing functions.

After the compiling process, the encoded instructions may then be loaded as computer-executable instructions or process steps to processor 1205 from storage device 1220, from memory 1210, and/or embedded within processor 1205 (e.g., via a cache or on-board ROM). Processor 1205 may be configured to execute the stored instructions or process steps in order to perform instructions or process steps to transform the computing device into a non-generic, particular, specially-programmed machine or apparatus. Stored data, e.g., data stored by a storage device 1220, may be accessed by processor 1205 during the execution of computer-executable instructions or process steps to instruct one or more components within the computing device 1200.

A user interface (e.g., output devices 1215 and input devices 1230) can include a display, positional input device (such as a mouse, touchpad, touchscreen, or the like), keyboard, or other forms of user input and output devices. The user interface components may be communicatively coupled to processor 1205. When the output device is or includes a display, the display can be implemented in various ways, including by a liquid crystal display (LCD) or a cathode-ray tube (CRT) or light emitting diode (LED) display, such as an OLED display. Persons of ordinary skill in the art are aware that the computing device 1200 may comprise other components well known in the art, such as sensors, power sources, and/or analog-to-digital converters, not explicitly shown in FIG. 12.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations may be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). The use of the term “about” means ±10% of the subsequent number, unless otherwise stated.

Use of the term “optionally” with respect to any element of a claim means that the element is required or, alternatively, the element is not required, both alternatives being within the scope of the claim. Use of broader terms, such as comprises, includes, and having, may be understood to provide support for narrower terms, such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present disclosure.

It is to be understood that the above description is intended to be illustrative and not restrictive. For example, the above-described embodiments may be used in combination with each other. Many other embodiments will be apparent to those of skill in the art upon reviewing the above description. The scope of the invention therefore should be determined with reference to the appended claims, along with the full scope of equivalents to which such claims are entitled. It should be noted that the discussion of any reference is not an admission that it is prior art to the present invention, especially any reference that may have a publication date after the priority date of this application.

What is claimed is:

1. A system comprising:
one or more hardware servers;
an enterprise management platform running on the one or more hardware servers, wherein the enterprise management platform is configured to host a plurality of instances, the plurality of instances individually or collectively comprising computer readable code to:
receive, from a task requestor, a request for candidate users for a first task, wherein the request comprises one or more request parameters;
identify, from a user directory, a first plurality of users based on the first task;
refine the first plurality of users to obtain the candidate users based on user metrics for each user provided by one or more community users, wherein the community users are different than the task requestor and the respective plurality of users, wherein the one or more request parameters indicates a perceived skill level of the respective user for the task by the one or more community users; and
transmit a message comprising the candidate users to the task requestor.

2. The system of claim 1, wherein the one or more request parameters identifies a requested asset, and wherein the computer readable code further comprises computer readable code to:
further refine the first plurality of users to include users with the requested asset based on the user directory.

3. The system of claim 1, further comprising computer readable code to:
determine, based on the candidate users, a suggested rate for each candidate user.

4. The system of claim 3, wherein the suggested rate is obtained from the user directory.

5. The system of claim 3, wherein the suggested rate is determined based on user assets identified from the user directory among the candidate users.

6. The system of claim 5, wherein the user assets are identified based on an indication of a technological enhancement of the user.

7. The system of claim 1, further comprising computer readable code to:
receive, from the task requestor, a selection of a candidate user; and
manage task metrics for the selected candidate user provided by the task requestor.

8. A non-transitory computer readable medium comprising computer readable code executable by one or more processors to:
receive, from a task requestor instance on an enterprise management platform, a request for candidate users for a first task, wherein the request comprises one or more request parameters;
identify, from a user directory, a first plurality of users based on the first task;
refine the first plurality of users to obtain the candidate users based on user metrics for each user provided by one or more community users, wherein the community users are different than the task requestor and the respective plurality of users, wherein the one or more request parameters indicates a perceived skill level of the respective user for the task by the one or more community users; and
transmit, to the task requestor instance, a message comprising the candidate users to the task requestor.

9. The non-transitory computer readable medium of claim 8, wherein the one or more request parameters identifies a requested asset, and wherein the computer readable code further comprises computer readable code to:
further refine the first plurality of users to include users with the requested asset based on the user directory.

10. The non-transitory computer readable medium of claim 8, further comprising computer readable code to:
determine, based on the candidate users, a suggested rate for each candidate user.

11. The non-transitory computer readable medium of claim 10, wherein the suggested rate is obtained from the user directory.

12. The non-transitory computer readable medium of claim 10, wherein the suggested rate is determined based on user assets identified from the user directory among the candidate users.

13. The non-transitory computer readable medium of claim 12, wherein the user assets are identified based on an indication of a technological enhancement of the user.

14. The non-transitory computer readable medium of claim 8, further comprising computer readable code to:
receive, from the task requestor, a selection of a candidate user; and
manage task metrics for the selected candidate user provided by the task requestor.

15. A method comprising:
receiving, from a task requestor instance on an enterprise management platform, a request for candidate users for a first task, wherein the request comprises one or more request parameters;
identifying, from a user directory, a first plurality of users based on the first task;
refining the first plurality of users to obtain the candidate users based on user metrics for each user provided by one or more community users, wherein the community users are different than the task requestor and the respective plurality of users, wherein the one or more request parameters indicates a perceived skill level of the respective user for the task by the one or more community users; and
transmitting, to the task requestor instance, a message comprising the candidate users.

16. The method of claim 15, wherein the one or more request parameters identifies a requested asset, and wherein the method further comprises:
further refining the first plurality of users to include users with the requested asset based on the user directory.

17. The method of claim 15, further comprising:
determining, based on the candidate users, a suggested rate for each candidate user.

18. The method of claim 17, wherein the suggested rate is determined based on user assets identified from the user directory among the candidate users.

19. The method of claim 18, wherein the user assets are identified based on an indication of a technological enhancement of the user.

20. The method of claim 1 further comprising:
receiving, from the task requestor, a selection of a candidate user; and
managing task metrics for the selected candidate user provided by the task requestor.
